(19) United States
(12) Patent Application Publication
(10) Pub. No.: US 2019/0346062 A1
(43) Pub. Date: Nov. 14, 2019

(54) Anti-Tamper Device

(71) Applicant: Michael Wall, Twin Falls, ID (US)

(72) Inventor: Michael Wall, Twin Falls, ID (US)

(21) Appl. No.: 16/403,834

(22) Filed: May 6, 2019

Related U.S. Application Data
(60) Provisional application No. 62/668,375, filed on May 8, 2018.

(51) Int. Cl. F16K 35/10; E05B 73/00; E05B 67/38; F17C 13/04

(52) U.S. Cl. CPC F16K 35/10; E05B 73/0005; F17C 2205/0173; F17C 13/04; F17C 2205/0308; E05B 67/383

(57) ABSTRACT

An anti-tamper device for securing a compressed gas tank that has a valve attached in a protruding manner. The anti-tamper device has a cylindrical body and a top cover. The cylindrical body has a hole located in the sidewall. The hole allows for a gas hose to be attached to the compressed gas tank. The sidewall further has a series of holes. The series of holes align in order to have a locking bar placed therein. The locking bar is designed such that the bar rests under a turn knob of the compressed gas tank. The locking bar is further designed to be placed under a handle of a compressed gas tank.

### CROSS REFERENCE TO RELATED APPLICATIONS

This application claims the benefit of U.S. Provisional Application No. 62/668,375 filed on May 8, 2018. The above identified patent application is herein incorporated by reference in its entirety to provide continuity of disclosure.

### BACKGROUND OF THE INVENTION

The present invention relates to a tank anti-tamper device. More particularly, the present invention provides a cover that cannot be removed without first removing a lock.

Gas tanks are commonly used as fuel in furnaces for heat, cooking, laundry dryers, barbecues, portable stoves and motor vehicles. Unfortunately, many gas tanks are stored outdoors. They are often left unattended too. This means that gas tanks are susceptible to being tampered with. Specifically, a gas connector hose may be taken or misplaced, or the gas turned on and left running. Given that the gas connector hose is vital for using the tank, and the loss of one could be extremely troublesome to a user, this is a major concern. Further, if gas is turned on unexpectedly, it can cause an extremely dangerous environment. Accordingly, an apparatus that ensures the securing of a gas tank, the gas connector hose and prevents the misplacement, or theft thereof, is desired.

Consequently, there is a need in for an improvement in the art of protecting a gas tank. The present invention substantially diverges in design elements from the known art, while at the same time solves a problem for many individuals. In this regard the present invention substantially fulfills these needs.

### SUMMARY OF THE INVENTION

The present invention provides an anti-tamper device for a gas tank wherein the same can be utilized for providing convenience for the user when using a portable gas tank. The present system comprises an anti-tamper device for a compressed gas tank that has a valve attached in a protruding manner. The device is placed over the valve such that it covers the entirety of the valve. The device has a side wall and a top to cover the valve. The side has two holes positioned across from one another to allow a lock bar to be placed therethrough, so the device cannot be removed without removing the lock bar. The lock bar is designed to allow for a lock to be placed on one end of the bar so that it cannot be removed without removing the lock.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself, and manner in which it may be made and used, may be better understood after a review of the following description, taken in connection with the accompanying drawings wherein like numeral annotations are provided throughout.

FIG. 1 shows a front view of an embodiment of the anti-tamper device attached to a gas tank.

FIG. 2 shows a top down view of an embodiment of the anti-tamper device attached to a gas tank.

FIG. 3 shows an exploded view of an embodiment of the individual components of the anti-tamper device.

FIG. 4 shows a front view of an embodiment of the device not attached to a gas tank.

FIG. 5 shows a front view of an embodiment of the anti-tamper device attached to a gas tank where the top is a closed portion.

### DETAILED DESCRIPTION OF THE INVENTION

Reference is made herein to the attached drawings. Like reference numerals are used throughout the drawings to depict like or similar elements of the anti-tamper device. For the purposes of presenting a brief and clear description of the present invention, a preferred embodiment will be discussed as used for the anti-tamper device. The figures are intended for representative purposes only and should not be considered to be limiting in any respect.

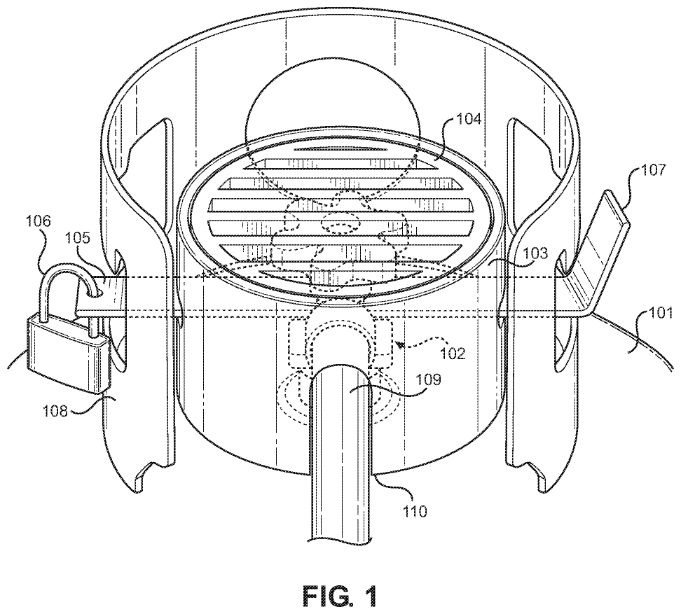

Referring now to FIG. 1, there is shown a front view of an embodiment of the anti-tamper device attached to a gas tank 101. The anti-tamper device covers the valve 102 entirely. The valve 102 will be inaccessible unless the anti-tamper device is removed. The device has a sidewall 103 and a top portion 104 that make up the protective covering. A lock bar 105 can be seen placed through holes in the device. This lock bar 105 is made from stainless steel or any other type of hard to break material such as aluminum, iron, or other metals. A padlock 106 can be attached to the lock bar 105. Any over the counter lock may be used. In this way convenience is provided to the user.

In one embodiment, the lock bar 105 can have a bent end 107 opposite the lock 106. In this embodiment, the bent end 107 is to prevent the lock bar 105 from passing completely through the handle 108 of the tank 101. One of ordinary skill in the art will understand that the bent end 107 can be in any number of configurations such that the lock bar 105 will not pass through the holes in the anti-tamper device. In one embodiment, the lock bar 105 is attached to the tank 101 via a handle or a locking loop or other methods. This will allow for multiple different types of tanks to be protected using the anti-tamper device. The anti-tamper device has a gas hose 109 that enters the device and attaches to the valve 102 via a hole 110 in the anti-tamper device. This hole 110 allows for the gas hose 109 to remain connected while the anti-tamper device is in use.

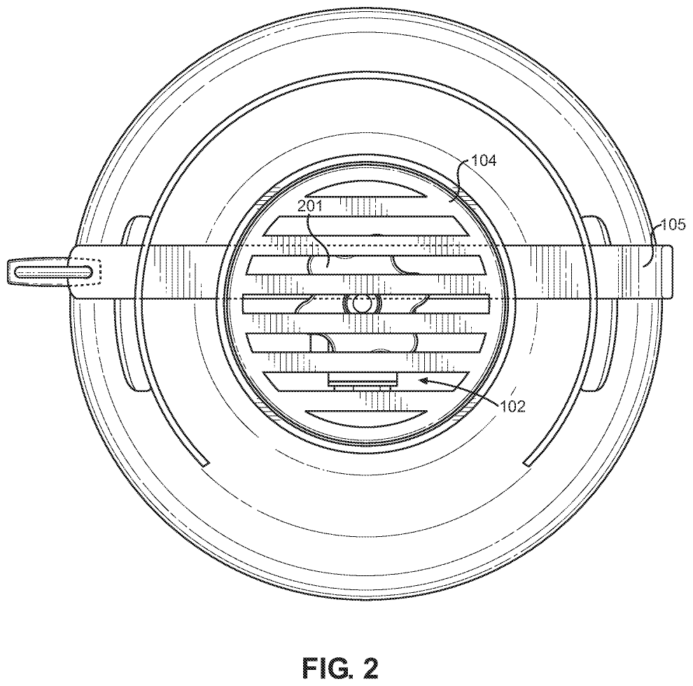

Referring to FIG. 2, there is shown a top down view of an embodiment of the anti-tamper device attached to a gas tank. The top portion 104 is shown to have slits in the top to allow gases to escape in case of a gas leak. The lock bar 105 is placed in such a manner that it is under a valve turn knob 201. The lock bar 105 is proportioned such that it will fit under the valve turn knob 201, but not so big that it will hit the stem of the valve. This will ensure that the anti-tamper device cannot be removed, even in the absence of a handle on the tank. Further, this top portion 104 will prevent access to the handle or the hose attachment.

In FIG. 1 and FIG. 2, the tank 101 is shown with the valve 102 on top of the tank 101, however this is merely one embodiment and is in no way meant to limit the invention. One of ordinary skill in the art will recognize that the present device can operate no matter where the valve is placed. Further, there is a handle in the FIG. 1 and FIG. 2. that add for extra security as seen in the description of FIG. 2. The anti-tamper device can be used by ensuring that the locking bar 105 is placed under the turn knob 201. Other attachments can also be incorporated on the tank, such as a locking loop or a chain.

The anti-tamper device can be a single piece, or a device comprised of multiple pieces. Further, the device can be made from various types of materials, for example but not limited to, polymer, PVC, plastic, or metal.

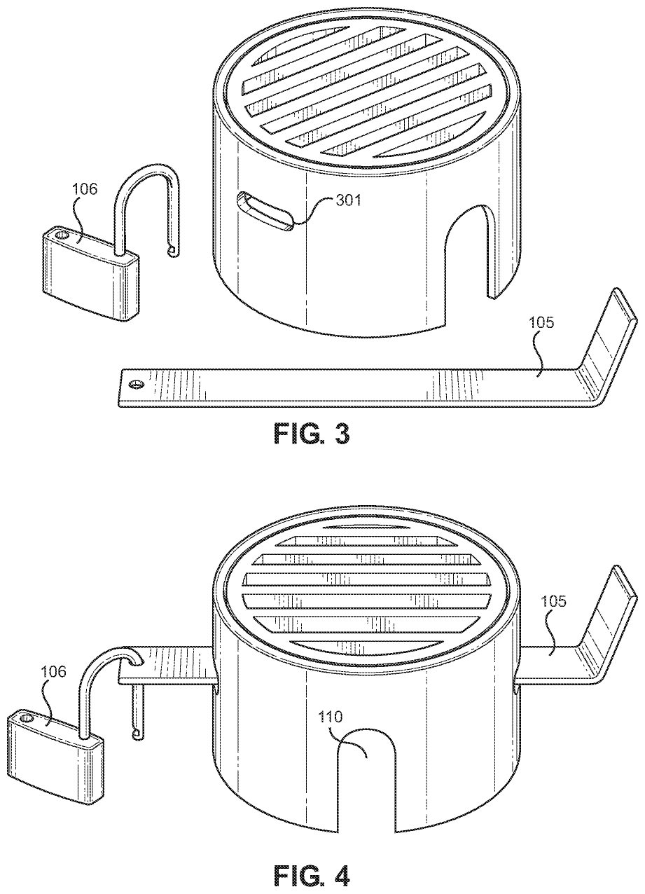

Referring now to FIG. 3, there is shown an exploded view of an embodiment of the anti-tamper device. The padlock 106 and the locking bar 105 can be seen removed from the anti-tamper device. From this angle, one of the holes for the locking bar 105 to be placed through can be seen. In this embodiment, there is a second hole placed in the device so that the locking bar can be placed through the device, forming a plurality of holes. This second hole can be placed in any number of places, from either directly opposite hole 301 or slightly off center of directly opposite hole 301. It is important that the holes be placed such that the locking bar 105 fits under the valve turn knob. In the depicted embodiment the lock bar 105 is flat. This will allow the lock bar 105 to be bent in the proper configuration. Further, this flat configuration will be harder to cut through or tamper with.

Referring now to FIG. 4, there is shown a front view of the device assembled but not attached to a gas tank. In this view, the hole 110 for the gas tube can be seen. Further, the locking bar 105 and the lock 106 can be seen attached to the anti-tamper device.

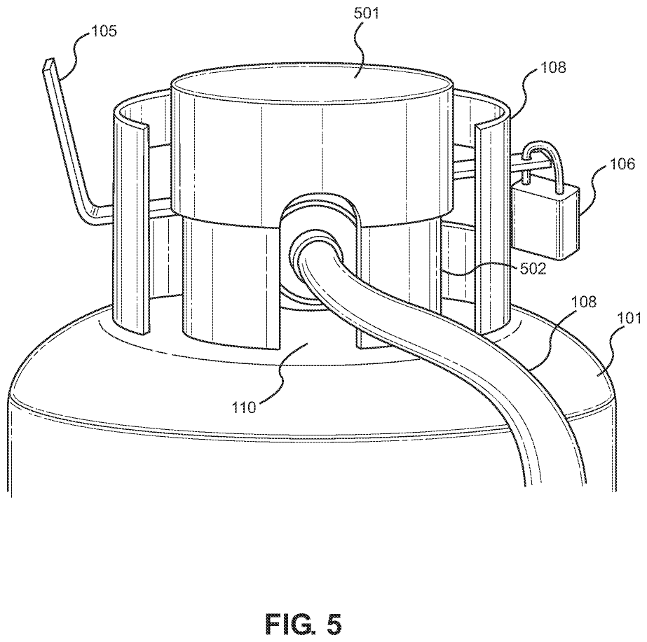

Referring now to FIG. 5, there is shown a front view of an embodiment of the anti-tamper device attached to a gas tank where the top is a closed portion. In this embodiment the top 501 of the anti-tamper device has no slits. The top 501 has a cylindrical side wall that is attached around the top. The top 501 has a diameter that is slightly bigger than the diameter of the bottom section 502. This will allow the top 501 to be placed over the bottom section creating the housing for the anti-tamper device. The device then has holes placed for the locking bar 105. The locking bar can be seen placed through the handle 108 of the tank 101. A padlock 106 is then placed in the lock bar 105 holding the anti-tamper device in place. In this embodiment, there is a hole 110 placed for the gas hose 109. This will allow the gas hose to remain attached when the anti-tamper device is locked to the tank.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An anti-tamper device, comprising:
a compressed gas tank comprising a top portion of the tank with a valve attached to the top portion in an upward protruding manner;
the device placed over the valve such that it covers the entirety of the valve;
the device having at least one side connected to a top portion;
the at least one side has at least two holes positioned across from one another, wherein the holes are configured to allow a lock bar to be placed therethrough, wherein the device cannot be taken off without removing the lock bar;
the lock bar having at least one hole on an end of the bar;
the at least one hole configured to allow for a lock to be placed therethrough locking the device to the tank.

2) The device of claim 1; wherein the at least one side is cylindrical.

3) The device of claim 1, wherein the top of the device has holes.

4) The device of claim 3, wherein the holes are slits.

5) The device of claim 1, wherein the device is made from plastic.

6) The device of claim 1 wherein the device is made of metal.

7) The device of claim 1, further comprising: the at least one side wall has an opening place therethrough, to allow for a hose to connect to the valve.

8) The device of claim 1, wherein the tank has a handle attached to the top portion of the tank.

9) The device of claim 8, wherein the lock bar is further configured to go through the handle.

10) An anti-tamper device, comprising:
a compressed gas tank comprising a valve attached to the tank such that it protrudes from the tank;
the device placed over the valve such that it covers the entirety of the valve;
the device having at least one side connected to a top portion;
the at least one side has at least two holes positioned across from one another, wherein the holes are configured to allow a lock bar to be placed therethrough, wherein the device cannot be taken off without removing the lock bar;
the lock bar having at least one hole on an end of the bar;
the at least one hole configured to allow for a lock to be placed therethrough locking the device to the tank.

11) The device of claim 10; wherein the at least one side is cylindrical;

12) The device of claim 10, wherein the top of the device has holes.

13) The device of claim 12, wherein the holes are slits.

14) The device of claim 10, wherein the device is made from plastic.

15) The device of claim 10, wherein the device is made of metal.

16) The device of claim 10, further comprising: the at least one side wall has an opening place therethrough, to allow for a hose to connect to the valve.

17) The device of claim 10, wherein the tank has a locking loop attached to the tank.

18) The device of claim 17, wherein the lock bar is further configured to go through the locking loop.
